(19) United States
(12) Patent Application Publication
(10) Pub. No.: US 2021/0276769 A1
(43) Pub. Date: Sep. 9, 2021

(54) Child-Resistant Closure

(71) Applicant: Plastek Industries, Inc., Erie, PA (US)

(72) Inventors: Timothy C. Dzurik, Erie, PA (US); Peter A. Piscopo, Medford, NJ (US)

(73) Assignee: Plastek Industries, Inc., Erie, PA (US)

(21) Appl. No.: 16/337,127

(22) PCT Filed: Oct. 30, 2017
(86) PCT No.: PCT/US2017/058968

§ 371 Date: Mar. 27, 2019

Related U.S. Application Data
(60) Provisional application No. 62/415,048, filed on Oct. 31, 2016.

(51) Int. Cl. B65D 50/04; A61J 1/03; B65D 47/08

(52) U.S. Cl. CPC B65D 50/046; B65D 2215/02; B65D 47/0804; A61J 1/03

(57) ABSTRACT

A closure comprises: a base for mounting to a container body neck; a cover; and a hinge coupling the cover to the base. The base comprises: an inner sidewall bearing a feature for engaging the neck; an outer sidewall spaced apart from the inner sidewall; an upper web coupling the inner sidewall to the outer sidewall; first and second apertures in the upper web; and first and second apertures in the outer sidewall. The cover comprises a first tab and a second tab. The cover has a closed condition, wherein: the first tab extends into the first aperture in the upper web; and the second tab extends into the second aperture in the upper web.

### CROSS-REFERENCE TO RELATED APPLICATION

Benefit is claimed of U.S. Patent Application No. 62/415,048, filed Oct. 31, 2016, and entitled “Child-Resistant Closure”, the disclosure of which is incorporated by reference herein in its entirety as if set forth at length.

### BACKGROUND

The disclosure relates to container closures. More particularly, the disclosure relates to child-resistant closures.

Among numerous examples of child-resistant closures for small over-the-counter (OTC) medications (e.g., pills, capsules, tablets) is U.S. Pat. No. 5,671,853 of Herr, issued Sep. 30, 1997. Herr discloses one particular screw-on closure.

### SUMMARY

One aspect of the disclosure involves a closure comprising: a base for mounting to a container body neck; a cover; and a hinge coupling the cover to the base. The base comprises: an inner sidewall bearing a feature for engaging the neck; an outer sidewall spaced apart from the inner sidewall; an upper web coupling the inner sidewall to the outer sidewall; and first and second apertures in the upper web. The cover comprises a first tab and a second tab. The cover has a closed condition, wherein: the first tab extends into the first aperture in the upper web; and the second tab extends into the second aperture in the upper web.

In one or more embodiments of any of the foregoing embodiments, the cover comprises a latching tab having a latching surface engaged to a latching surface of the base in the closed condition.

In one or more embodiments of any of the foregoing embodiments, the latching tab latching surface is a lower surface of a projection along an inboard surface of the latching tab.

In one or more embodiments of any of the foregoing embodiments, the base, cover, and hinge are unitarily molded as a single piece.

In one or more embodiments of any of the foregoing embodiments, the base, cover, and hinge are molded plastic.

In one or more embodiments of any of the foregoing embodiments, a container comprises the closure and further comprises a container body having a neck to which the base is mounted.

In one or more embodiments of any of the foregoing embodiments, the container further comprises a plurality of pills, tablets, capsules, or gellcaps in the container body.

In one or more embodiments of any of the foregoing embodiments, said plurality of pills, tablets, capsules, or gellcaps in the container body are multivitamins.

In one or more embodiments of any of the foregoing embodiments, a method for using the closure comprises inwardly pressing on the first tab and the second tab and rotating the cover to an open condition.

In one or more embodiments of any of the foregoing embodiments, the method further comprises pulling a latching tab of the cover.

In one or more embodiments of any of the foregoing embodiments, the inwardly pressing releases a backlocking engagement.

Another aspect of the disclosure involves a closure comprising: a base for mounting to a container body neck; a cover; and a hinge coupling the cover to the base. The base comprises: an inner sidewall bearing a feature for engaging the neck; an outer sidewall spaced apart from the inner sidewall; an upper web coupling the inner sidewall to the outer sidewall; and an aperture in the upper web. The cover comprises: a tab. In a closed condition, the tab extends through the aperture in the upper web.

Another aspect of the disclosure involves a method for opening a closure of a container from a closed condition to an open condition. The closure comprises: a base mounted to a neck of a body of the container; a cover having a first tab and a second tab; and a hinge coupling the cover to the base. The method comprises: inwardly pressing on the first tab and the second tab and rotating the cover to an open condition.

In one or more embodiments of any of the foregoing embodiments, in the closed condition, respective exposed portions of the first tab and the second tab are exposed below respective locking portions of the base; and the inwardly pressing comprises contacting the respective exposed portions.

In one or more embodiments of any of the foregoing embodiments, the inwardly pressing comprises contacting the respective tabs with a thumb and another finger of a given hand of a user.

In one or more embodiments of any of the foregoing embodiments, the method further comprises pulling a latching tab of the cover.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a first view of a container having a closure in an open condition.

FIG. 2 is a second view of the container.

FIG. 3 is a side view of the container.

FIG. 4 is a top view of the container.

FIG. 5 is a bottom view of the container.

FIG. 6 is a central longitudinal/vertical sectional view of the container taken along lines 6-6 of FIG. 4.

FIG. 7 is a view of the closure in a closed condition.

FIG. 8 is a side view of the closed closure.

FIG. 9 is a transverse vertical sectional view of the closure taken along line 9-9 of FIG. 8.

FIG. 10 is a horizontal sectional view of the closure taken along line 10-10 of FIG. 8.

FIG. 11 is a view of a body of the container.

Like reference numbers and designations in the various drawings indicate like elements.

### DETAILED DESCRIPTION

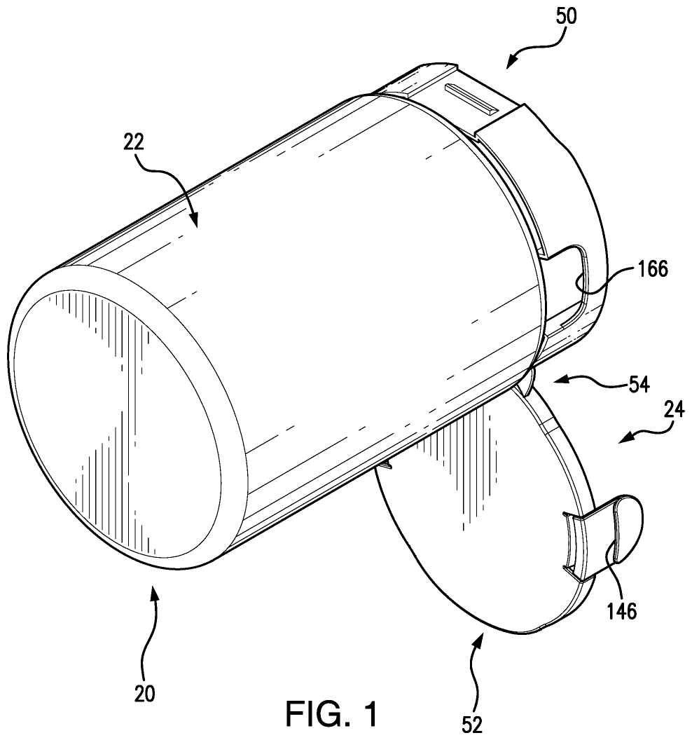

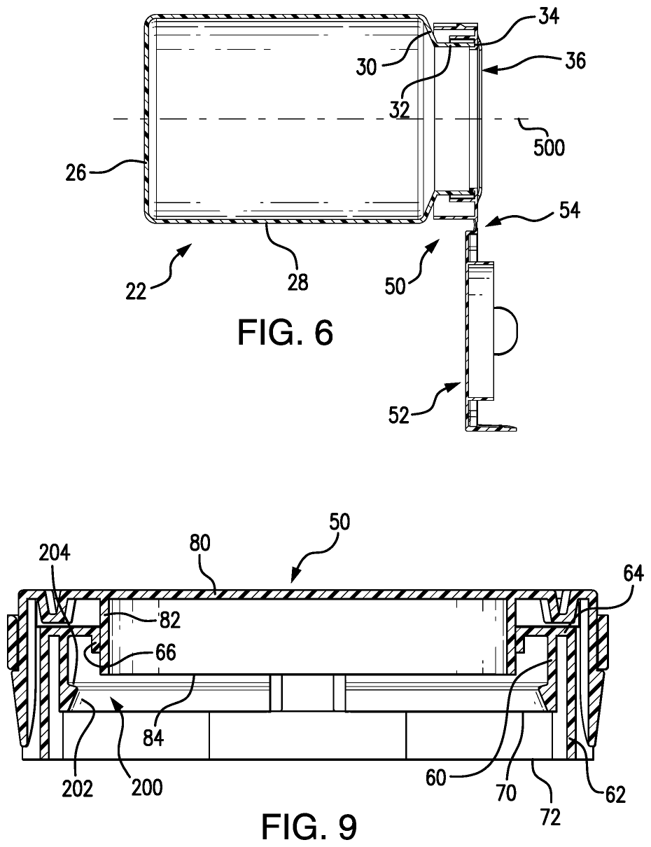

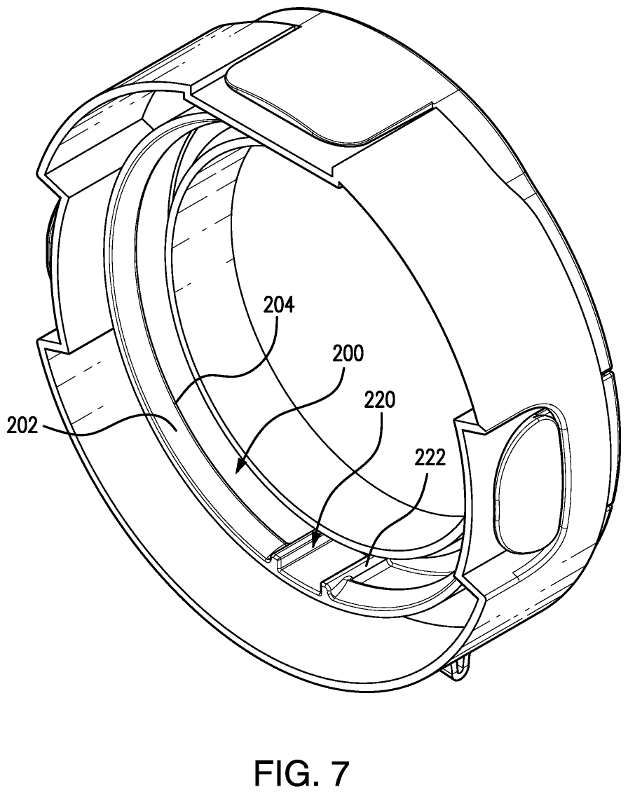

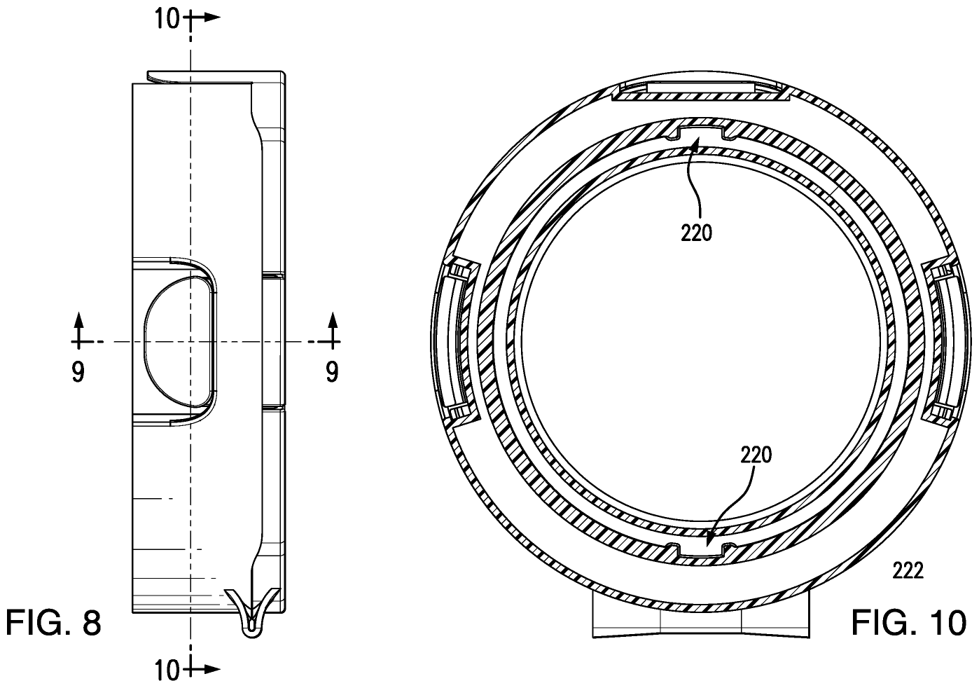

FIG. 1 shows a container 20 comprising a container body 22 and a closure 24. The exemplary body 22 (FIG. 6) comprises a bottom or base 26 and a sidewall 28 extending upward from the base. The exemplary side wall encircles a central longitudinal axis 500 (FIG. 6) which is a vertical axis when the bottle is in an upright condition.

The sidewall extends up to a shoulder 30 which, in turn, extends to a neck 32 extending to a rim 34 defining a mouth 36 of the body. The exemplary body comprises a single molded piece (e.g., injection blow molded) of a plastic material such as polyethylene terephthalate (PET) or polypropylene (PP).

The exemplary closure 24 is also formed of a single molded piece (e.g., injection molded) of plastic such as co-polymer polypropylene (COPP). The closure may be molded in an open condition. The exemplary closure comprises a base 50 and a lid or cover 52 coupled to the base via a living hinge 54. As is discussed below, the base bears features for mounting to the body (e.g., snap features).

The base has an inner sidewall 60 (FIG. 9) and an outer sidewall 62. The inner sidewall 60 bears the features for mounting to the body neck. The inner sidewall 60 and outer sidewall 62 respectively extend upward from lower rims 70 and 72. The exemplary rim 70 is vertically recessed relative to the rim 72.

The sidewalls 60 and 62 extend upward to an upper web or flange 64 coupling the inner sidewall to the outer sidewall 62. The exemplary web 64 extends radially inward past the inner sidewall 60 to a short vertical wall or boss 66 depending from the web 64 at a central opening thereof.

The cover 50 comprises a transverse web 80 with a central sidewall or collar 82 depending from the underside of the web 80 to a lower rim 84. In the closed position, the sidewall 82 is received within the boss 66 in a tight sealing relation.

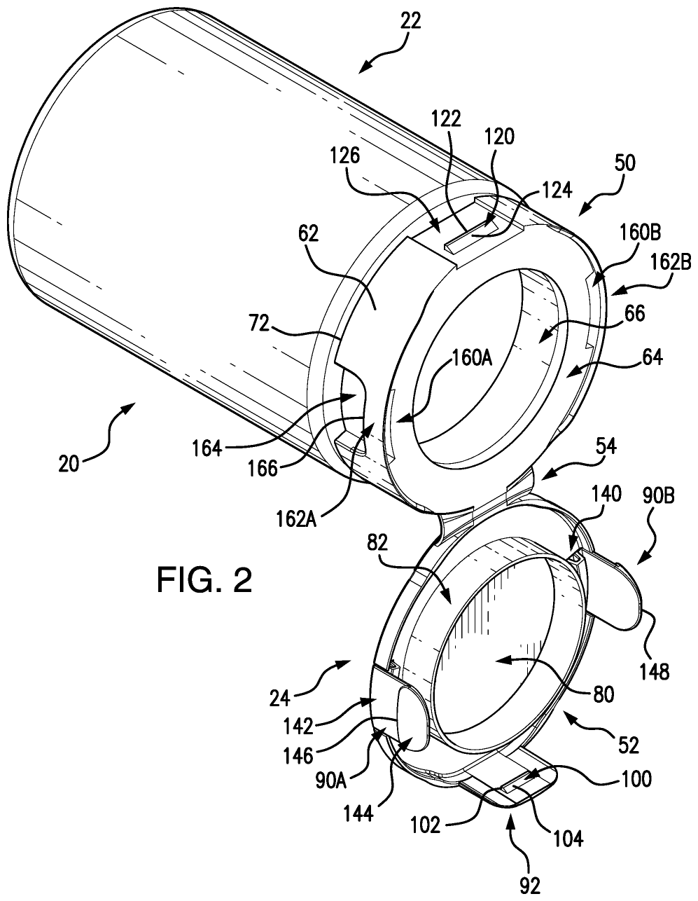

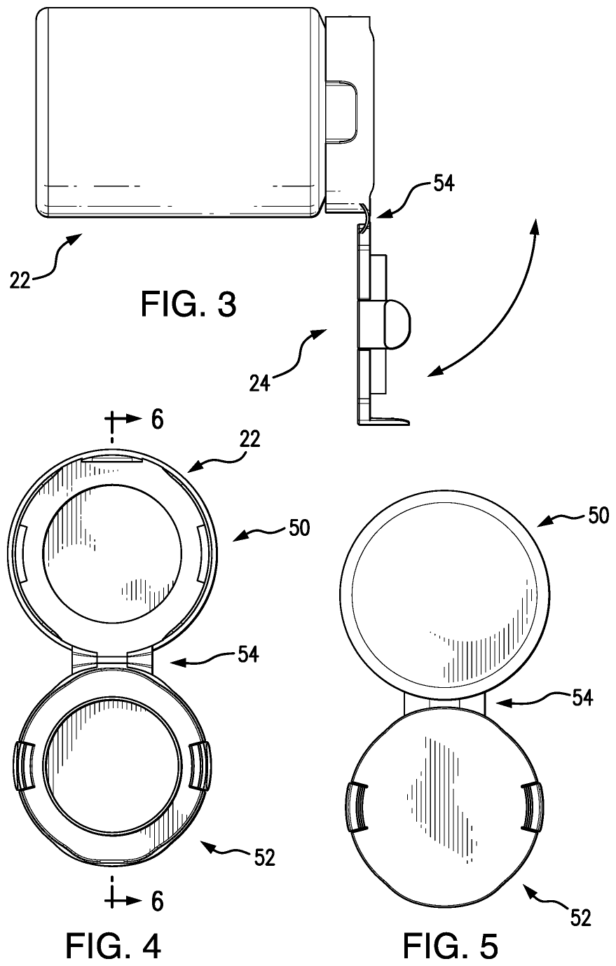

FIG. 2 shows the cover 50 including three depending tabs 90A, 90B, and 92. Exemplary tabs depend from a peripheral portion of the transverse web 80 outboard of the sidewall 82. Each of the tabs has a latching function discussed below. The tab 92 is opposite the hinge 54 and bears an interior latching projection 100 having a locking/latching surface 102 and a camming surface 104. This projection 100 cooperates with a projection 120 on the base having a locking/latching surface 122 and a camming surface 124. The exemplary projection 120 falls along a radial recess 126 in the outer sidewall 62. When the cover is closed from the open condition of FIG. 2 by hinging about the axis of the hinge 54, the camming surfaces 104 and 124 eventually engage each other to radially outwardly shift the tab 92 briefly until the projections pass over each other. Thereafter, the tab 92 relaxes radially inward and the surfaces 102 and 122 abut and backlock to resist extraction/removal of the closure. Release/opening is discussed below.

The projections 90A and 90B each have a proximal radial spring portion 140 allowing inward radial compression from the as-molded condition. The exemplary projections 90A and 90B are diametrically offset from each other orthogonal to the hinge 54 and tab 92. Each of the projection 90A, 90B has an upper (when in the closed condition and container upright) portion 142 and a lower portion 144. Alternatively characterized, the lower portion 144 is a distal portion, with the radial spring portion 140 being proximal and the upper portion 142 being distal thereof and proximal of the lower portion 144.

The lower portion 144 is thickened to radially outwardly protrude from the upper portion 142 and create a stop surface 146. The lower portion 144 thins from the outboard side towards its lower end 148. The tapering associated with this thinning allows the tabs 90A and 90B, upon closing, to initially pass into respective slots 160A and 160B of the base. Outboard boundaries of the slots 160A and 160B are formed by associated wall portions or sections 162A and 162B. These wall portions 162A and 162B may alternatively be defined as portions of the outer sidewall 62 or as an additional wall spanning between sections of the sidewall 62 which are spaced apart by a radially recessed portion 164 of the outer sidewall 162. In the former definition, the portion 164 would be an additional intermediate wall merely coextensive with the slots.

The wall portions 162A and 162B are partial height, leaving a lower edge portion 166 radially recessed relative to a main portion of the lower rim 72. When the cover is closed from the open condition, the lower portions 144 of the tabs 90A and 90B pass into the slots and their outboard surfaces are guided by the inboard surface of the wall portions 162A and 162B, along the slots. Further closing causes the tabs 90A and 90B to be compressed radially inward as the thickened portion of the lower portion engages the sidewall portion 162A, 162B. Eventually, however, the lower edge/stop surface 146 passes the sidewall portions 162A and 162B and snaps outward to backlock against the rim surface portion 166. Thus, in the closed condition, all three tabs are backlocked to hold the cover in the closed condition.

With the cover in the closed condition, the outer/outboard surface of the tab lower portions 144 are radially exposed. A user can grasp (such as with thumb and forefinger of one hand) the two lower portions 144 and compress them inward. This compressing releases the backlock engagement of the surfaces 146 and 166. With another hand the user may outwardly pry the tab 92 to release the backlocking of the surfaces 102 and 122 and thereby free the cover to rotate back to the open condition. Bias of the hinge 54 may encourage the cover to return toward the as-molded condition, but the relaxed open condition may fall short of the as-molded condition.

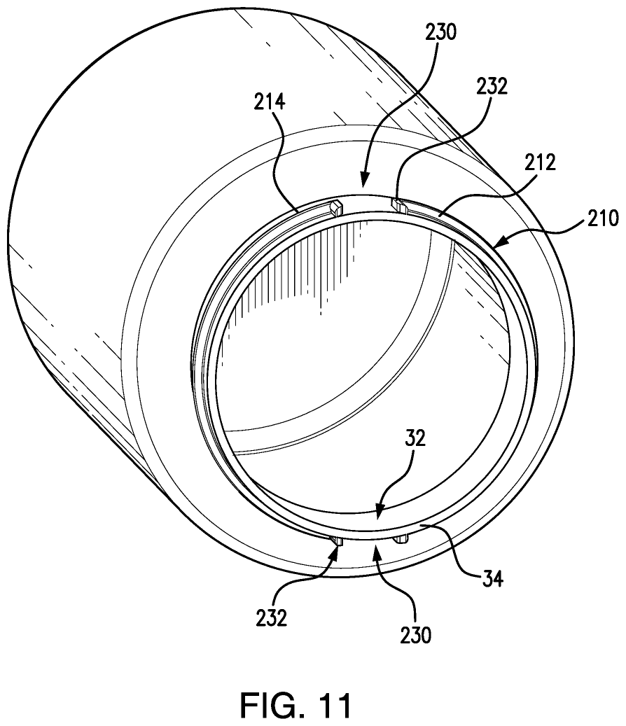

For mounting the closure to the body, exemplary snap features comprise circumferential barbs. FIG. 7 shows a barb 200 having a camming surface 202 and a locking surface 204 protruding radially inward from the base inner sidewall. FIG. 11 shows a complementary barb 210 on the outer surface of the neck 32 and having an upper camming surface 212 and a lower locking surface 214. A downward instillation of the closure causes the camming surfaces 202 and 212 to initially engage each other and allow elastic deformation (outward for the projection 200 and inward for the projection 210) until the projections pass over each other and snap into locked engagement with the surfaces 204 and 214 backlocking against each other. If it is desired to angularly orient the closure relative to the body, orientation features may be provided. FIGS. 7 and 11 show pairs of vertical ribs 220, 230 along the base inner sidewall inboard surface and neck outboard surface, respectively. In the exemplary embodiment, the pairs 220 snap within the pairs 230.

Child-resistance may come from a combination of factors which may vary across embodiments. One factor is complexity of manipulation. Pressing the two tabs 90A and 90B imposes a threshold level of complexity. In embodiments having the third tab 92, pulling of that tab adds further complexity. Size also is relevant. For single handed release, the user's hand must be large enough span the diameter of the top of the closure and allow the engaging fingers (e.g., thumb plus forefinger or another finger) to reach down past the sidewall portions 162A and 162B. Exemplary diameters are 60 mm to 70 mm, more broadly 50 mm to 80 mm. Required force (which may be controlled by selection of material thickness, etc.) is also a factor. Depending on the nature of the products being dispensed, different levels of child-resistance may be required. For example, some vitamins may be subject to no regulatory requirement for child-resistant containers. A variation offering less resistance may be acceptable with these. At the other end of the spectrum, some variations may be sufficient for prescription drugs.

The use of “first”, “second”, and the like in the description and following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

Where a measure is given in English units followed by a parenthetical containing SI or other units, the parenthetical's units are a conversion and should not imply a degree of precision not found in the English units.

One or more embodiments have been described. Nevertheless, it will be understood that various modifications may be made. For example, when applied to an existing basic system, details of such configuration or its associated use may influence details of particular implementations. Accordingly, other embodiments are within the scope of the following claims.

1. A closure comprising:
a base for mounting to a container body neck;
a cover; and
a hinge coupling the cover to the base,
wherein:
the base comprises:
an inner sidewall bearing a feature for engaging the neck;
an outer sidewall spaced apart from the inner sidewall;
an upper web coupling the inner sidewall to the outer sidewall;
first and second apertures in the upper web; and
first and second apertures in the outer sidewall;
the cover comprises:
a first tab and a second tab; and
the cover has a closed condition wherein:
the first tab extends into the first aperture in the upper web;
the second tab extends into the second aperture in the upper web;
the first tab has a portion radially exposed below a portion of the outer sidewall above the first aperture in the outer sidewall; and
the second tab has a portion radially exposed below a portion of the outer sidewall above the second aperture in the outer sidewall.

2. The closure of claim 1 wherein:
the cover comprises a latching tab having a latching surface engaged to a latching surface of the base in the closed condition.

3. The closure of claim 2 wherein:
the latching tab latching surface is a lower surface of a projection along an inboard surface of the latching tab.

4. The closure of claim 1 wherein:
the base, cover, and hinge are unitarily molded as a single piece.

5. The closure of claim 1 wherein:
the base, cover, and hinge are molded plastic.

6. A container comprising the closure of claim 1 and further comprising:
a container body having a neck to which the base is mounted.

7. The container of claim 6 further comprising:
a plurality of pills, tablets, capsules, or gellcaps in the container body.

8. The container of claim 7 wherein:
said plurality of pills, tablets, capsules, or gellcaps in the container body are multivitamins.

9. A method for using the closure of claim 1, the method comprising:
inwardly pressing on the first tab and the second tab; and
rotating the cover to an open condition.

10. The method of claim 9 further comprising:
pulling a latching tab of the cover.

11. The method of claim 9 wherein:
the inwardly pressing releases a backlocking engagement.

12. The method of claim 9 further comprising:
during said inwardly pressing, pulling a latching tab of the cover.

13. A method for opening a closure of a container from a closed condition to an open condition, the closure comprising:
a base mounted to a neck of a body of the container;
a cover having a first tab and a second tab and a latching tab; and
a hinge coupling the cover to the base,
the method comprising:
inwardly pressing on the first tab and the second tab while pulling on the latching tab; and
rotating the cover to an open condition.

14. The method of claim 13 wherein:
in the closed condition, respective exposed portions of the first tab and the second tab are exposed below respective locking portions of the base; and
the inwardly pressing comprises contacting the respective exposed portions.

15. The method of claim 13 wherein:
the inwardly pressing comprises contacting the respective tabs with a thumb and another finger of a given hand of a user.

16. The method of claim 13 wherein:
the pulling the latching tab of the cover and the inwardly pressing are done with a single hand.

17. A method for opening a closure of a container from a closed condition to an open condition, the closure comprising:
a base mounted to a neck of a body of the container;
a cover having a first tab and a second tab; and
a hinge coupling the cover to the base,
the method comprising:
inwardly pressing on the first tab and the second tab; and
rotating the cover to an open condition,
wherein:
in the closed condition, respective exposed portions of the first tab and the second tab are exposed below respective locking portions of the base; and
the inwardly pressing comprises contacting the respective exposed portions.

18. The method of claim 17 wherein:
the inwardly pressing releases a backlocking engagement.
